(19) United States
(12) Patent Application Publication
(10) Pub. No.: US 2009/0025582 A1
(43) Pub. Date: Jan. 29, 2009

(54) SCREEN PRINTING METHOD FOR PRINTING A PRINTED CIRCUIT BOARD

(75) Inventors: TSO-HUNG YEH, Tayuan (TW); CHIH-KANG YANG, Tayuan (TW); HUNG-YI CHANG, Tayuan (TW); CHIH-LUNG HSIAO, Tayuan (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN ADVANCED TECHNOLOGY INC., Tayuan (TW)

(21) Appl. No.: 11/952,964

(22) Filed: Dec. 7, 2007

(30) Foreign Application Priority Data
Jul. 27, 2007 (CN) 200710075431.4

(51) Int. Cl. B41M 1/12

(52) U.S. Cl. 101/129

(57) ABSTRACT

An exemplary screen printing method for printing a printed circuit board is provided. The printed circuit board includes a number of parallel electrical traces. In the method, firstly, a screen printing stencil is disposed on a side of the printed circuit board having the electrical traces and a squeegee is disposed on the screen printing stencil. Secondly, the squeegee is drawn across the screen printing stencil in a manner such that an angle between a blade of the squeegee and the electrical traces is in a range from 20 degrees to 70 degrees so as to print an ink on the printed circuit board. The method can improve quality of the printed circuit board.

### BACKGROUND

1. Technical Field

The present invention relates to screen printing, more particularly to a screen printing method for printing a printed circuit board.

2. Description of Related Art

Screen printing is a versatile printing technique. Screen printing can be used to print on a wide variety of substrates, including paper, paperboard, plastics, glass, metals and fabrics. Nowadays, screen printing plays an important role in manufacturing a printed circuit board. For example, a solder resist ink is often applied on the printed circuit board to form a protective layer by a screen printing method. The screen printing method for printing the solder resist ink on the printed circuit board often employs a stencil having a predetermined pattern. The stencil is placed on the printed circuit board at first, and then solder resist ink is applied onto the stencil. Then a squeegee is drawn across the stencil so that the solder resist ink is squeezed through fine mesh openings of the stencil. Therefore, a solder resist ink pattern can be printed on the printed circuit board.

Generally, the printed circuit board may include a number of electrical traces formed thereon in advance. Each two neighboring electrical traces define an interspace therebetween. In a typical process of screen printing, the solder resist ink is applied on the printed circuit board and the squeegee is drawn across the stencil in a manner such that a blade of the squeegee is parallel to the electrical traces. However, in a circumstance where the electrical traces are thick, a depth of the interspace between two neighboring electrical traces is correspondingly deep. When the blade of the squeegee is parallel to the electrical traces, the blade and edges of the electrical traces may be in a linear contact manner. During screen printing, the blade may get in the interspace between two neighboring electrical traces. Thus, the solder resist ink may be extruded from the interspaces towards a direction opposite to a movement direction of the squeegee. Therefore, the solder resist ink remained may be insufficient to fill into the interspaces. In addition, the solder resist ink applied on edges of the electrical traces will flow into the interspaces due to gravity and fluidity, especially, an edge of each electrical trace contacting with the blade. As a result, the solder resist ink may not applied on edges of electrical traces, thereby lowering a quality of the printed circuit board.

What is needed, therefore, is a screen printing method for printing a printed circuit board having electrical traces with thick thicknesses.

### SUMMARY

One present embodiment provides a method for screen printing a printed circuit board. The printed circuit board includes a number of parallel electrical traces. In the method, firstly, a screen printing stencil is disposed on a side of the printed circuit board having the electrical traces and a squeegee is disposed on the screen printing stencil. Secondly, the squeegee is drawn across the screen printing stencil in a manner such that an angle between a blade of the squeegee and the electrical traces is in a range from 20 degrees to 70 degrees so as to print an ink on the printed circuit board.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic view of a printed circuit board for screen printing according to a present embodiment.

FIG. 2 is a schematic, cross-sectional view of the printed circuit board of FIG. 1 as viewed along line II-II.

FIG. 3 is a schematic view of the printed circuit board having a screen printing stencil and a squeegee disposed thereon.

FIG. 4 is a schematic, top view of the screen printing stencil shown in FIG. 3.

FIG. 5 is a schematic view of a method for screen printing the printed circuit board shown in FIG. 1.

### DETAILED DESCRIPTION OF THE EMBODIMENTS

Embodiment will now be described in detail below with reference to the drawings.

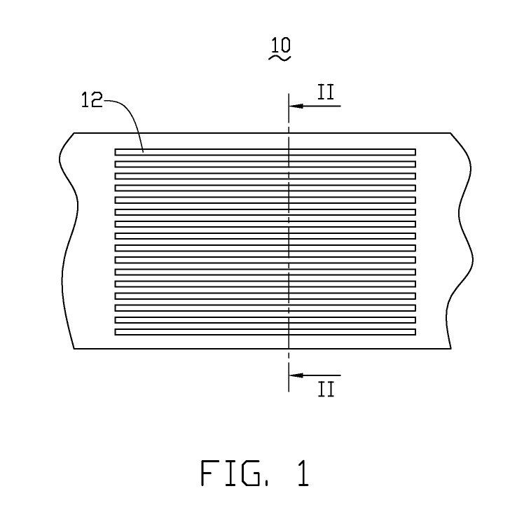

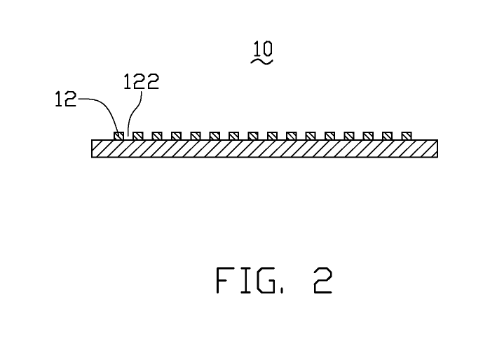

Referring to FIG. 1 and FIG. 2, a printed circuit board 10 is shown. The printed circuit board 10 is ready for screen printing a functional layer thereon. The functional layer can be a solder resist layer. Therefore, screen printing a solder resist ink on the printed circuit board 10 to form the solder resist layer will be described in detail in this exemplary embodiment.

The printed circuit board 10 has a number of electrical traces 12 formed thereon. The electrical traces 12 are parallel to each other. The electrical traces 12 can be made of a copper conductive layer. Generally, thicknesses of the electrical traces 12 are determined by a thickness of the copper conductive layer. In the present embodiment, a thickness of each electrical trace 12 is thick. For example, the thickness of each electrical trace 12 or an average thickness of all electrical traces 12 is either equal to or more than 18 micrometers. Each two neighboring electrical traces 12 define an interspace 122 therebetween. A depth of the interspace 122 is equal to the thickness of two neighboring electrical traces 12.

An exemplary screen printing method for printing the printed circuit board 10 includes the following steps.

Step 1: a screen printing stencil 20 and a squeegee 32 is disposed on the printed circuit board 10.

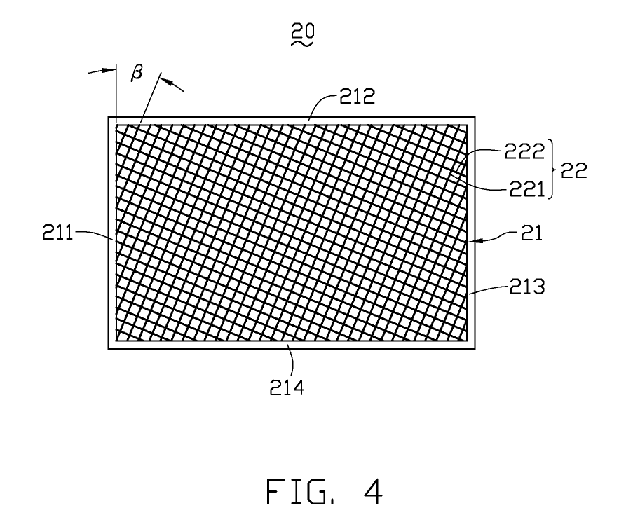

Referring to FIG. 4, the screen printing stencil 20 includes a screen frame 21 and a screen mesh 22. The screen frame 21 includes a first rim 211, a second rim 212, a third rim 213 and a fourth rim 214, which connects in sequence to form a rectangular frame. The screen frame 21 can be made a material selected form a group consisting of metal, wood and plastic. It is noted that the screen frame 21 can be in various shapes according to various demands.

The screen mesh 22 includes a number of first silks 221 and a number of second silks 222 intersecting the first silks 221 perpendicularly. The first silks 221 are parallel to each other; similarly, the second silks 222 also are parallel to each other. Peripheral edges of the screen mesh 22 are attached to peripheral inner sides of the first rim 211, the second rim 212, the third rim 213 and the fourth rim 214 of the screen frame 21. Thus, the screen mesh 22 is stretched to and attached to the screen frame 21 under tension. The screen mesh 22 attached to the screen frame 21 has elasticity and tension. The first silks 221 and the second silks 222 of the screen mesh 22 is attached to the screen frame 21 in a bias manner. In other words, the bias manner means that an angle between one of the silks and the corresponding rim that the one of the silks are attached is an acute angle. The acute angle is called a bias angle. For example, the bias angle β between the first silk 221 and the first rim 211 can either be 45 degrees or 22.5 degrees. In the present embodiment, the bias angle β between the first silk 221 and the first frame 211 is approximate 22.5 degrees. It is understood that, the bias angle can also refers to an acute angle between the second silk 222 and the second frame 212, which is equal to the bias angle β and is also approximate 22.5 degrees.

The screen mesh 22 can be selected from a group consisting of a polyester screen mesh, a nylon screen mesh and a metal screen mesh. In the prefer embodiment, the screen mesh 22 is a polyester screen mesh. The first silks 221 and the second silks 222 are made of polyester.

The squeegee 32 has a blade 321. The blade 321 is linear shaped.

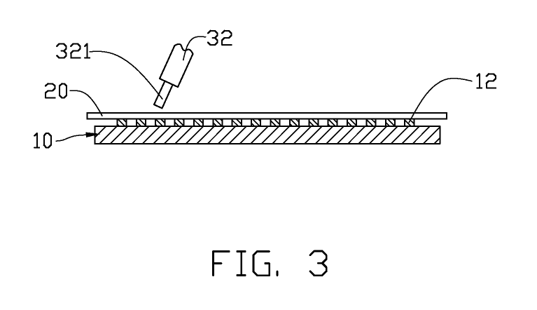

Referring to FIG. 3, firstly, the screen printing stencil 20 is disposed on the electrical traces 12 of the printed circuit board 10 in a manner that screen mesh 22 contacts with the electrical traces 12. Secondly, the squeegee 32 is disposed on screen printing stencil 20 of the screen printing stencil 20 in a manner such that the blade 321 contacts with the screen mesh 22. The squeegee 32 can be drawn across the screen mesh 22 to squeeze ink through the screen mesh 22, thereby forming a screen pattern on the printed circuit board 10.

Step 2: the squeegee 32 is drawn across the screen printing stencil 20 along a predetermined direction in a manner such that an angle between the blade 321 of the squeegee 32 and the electrical traces 12 is in a range from 20 to 70 degrees so as to print a solder resist ink on the printed circuit board 10.

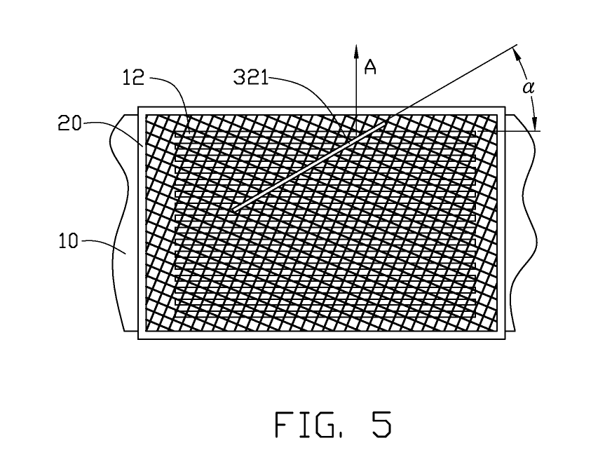

Referring to FIG. 5, the blade 321 is adjusted to intersect with the electrical traces 12. An angle α between the blade 321 and the electrical traces 12 is adjusted in an approximate range from 20 to 70 degrees. Preferably, the angle α is adjusted in an approximate range from 30 to 45 degrees.

Referring to FIG. 5, the squeegee 32 is drawn across the screen printing stencil 20 along a predetermined direction. In the present embodiment, during the movement of the squeegee 32, a direction A that the squeegee 32 moves along is perpendicular to the electrical traces 12. Thus, a solder resist ink can be squeezed through the screen mesh 22 to be applied onto the printed circuit board 10. The solder resist ink can be applied onto the electrical traces 12 and be filled into the interspaces 122. Because the angle α between the blade 321 and the electrical traces 12 is in an approximate range from 20 to 70 degrees, the blade 321 and edges of the electrical traces 12 are in a point-contact manner, that is, only a very small area of the blade 321 contacts with each of the electrical traces 12. During drawing the squeegee 32 across the screen printing stencil 20, the blade 321 cannot get in the interspaces 122. Thus, the solder resist ink would not be extruded from the interspaces 122. Therefore, the printing quality of the solder resist ink is improved. The electrical traces 12 can be applied/covered with the solder resist ink sufficiently, and solder resist ink can fully filled into the interspaces 122.

Additionally, because the angle α between the blade 321 and the electrical traces 12 is in an approximate range from 20 degrees to 70 degrees, the solder resist ink is filled into the interspaces 122 in bias manner. Thus, the solder resist ink is printed between each two neighboring electrical traces 12 uniformly.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A screen printing method for printing a printed circuit board, the printed circuit board comprising a plurality of parallel electrical traces, the method comprising the steps of:
disposing a screen printing stencil on a side of the printed circuit board having the electrical traces thereon, and a squeegee on the screen printing stencil; and
drawing the squeegee across the screen printing stencil in a manner such that an angle between a blade of the squeegee and the electrical traces is in a range from 20 degrees to 70 degrees to print an ink on the printed circuit board.

2. The screen printing method as claimed in claim 1, wherein the angle of the blade of the squeegee and the electrical traces is in a range from 30 to 45 degrees.

3. The screen printing method as claimed in claim 1, wherein a movement direction of the squeegee drawing across the screen printing stencil is perpendicular to the electrical traces.

4. The screen printing method as claimed in claim 1, wherein the screen printing stencil comprises a screen frame and a screen mesh attached to the screen frame under tension, the screen frame is comprised of a material selected form a group consisting of metal, wood and plastic.

5. The screen printing method as claimed in claim 4, wherein the screen mesh is selected from a group consisting of a polyester screen mesh, a nylon screen mesh and a metal screen mesh.

6. The screen printing method as claimed in claim 4, wherein the screen mesh comprises a plurality of first silks and a plurality of second silks intersecting the first silks perpendicularly, the first silks are parallel to each other and the second silks are parallel to each other.

7. The screen printing method as claimed in claim 1, wherein the screen mesh is attached to the frame in a bias manner.

8. The screen printing method as claimed in claim 1, wherein a bias angle is either 45 degrees or 22.5 degrees.

9. The screen printing method as claimed in claim 1, wherein a thickness of each electrical trace is either equal to or more than 18 micrometers.

10. The screen printing method as claimed in claim 1, wherein an average thickness of all electrical traces is either equal to or more than 18 micrometers.
